(19) United States
(12) Patent Application Publication
(10) Pub. No.: US 2020/0244724 A1
(43) Pub. Date: Jul. 30, 2020

(54) INFORMATION PROCESSING DEVICE AND TERMINAL

(71) Applicant: FUJITSU LIMITED, Kawasaki-shi (JP)

(72) Inventors: Tadanobu Tsunoda, Kawasaki (JP); Koichi Yasaki, Kawasaki (JP); Kazuaki Nimura, Kawasaki (JP)

(73) Assignee: FUJITSU LIMITED, Kawasaki-shi (JP)

(21) Appl. No.: 16/749,527

(22) Filed: Jan. 22, 2020

(30) Foreign Application Priority Data
Jan. 29, 2019 (JP) 2019-012786

(51) Int. Cl. H04L 29/08; H04L 9/08; G06F 21/62

(52) U.S. Cl. CPC H04L 67/1029; H04L 67/1097; G06F 21/6209; H04L 9/0822; H04L 67/1014

(57) ABSTRACT

An information processing device includes a memory; and a processor coupled to the memory and the processor configured to: acquire file data to be used by a terminal; generate multiple tallies from the file data; transmit at least one tally among the multiple tallies to an external device; generate attribute information including information of the file data and information of the external device; transmit, to the terminal, the generated attribute information and the multiple tallies except for the at least one tally transmitted to the external device; and transmit the attribute information to the external device.

### CROSS-REFERENCE TO RELATED APPLICATION

This application is based upon and claims the benefit of priority of the prior Japanese Patent Application No. 2019-12786, filed on Jan. 29, 2019, the entire contents of which are incorporated herein by reference.

### FIELD

The embodiments discussed herein are related to an information processing device and a terminal.

### BACKGROUND

A load balancing technique using an edge computer has been proposed as a technique for inhibiting a load which occurs due to intensive access to data stored in a cloud server. This load balancing is realized by caching a copy of the data in an edge computer to which a terminal located near uses the cache instead of using the original data in the cloud server.

In this case, since the edge computer may be set in a room where anyone can enter and leave, there is a risk that the edge computer or a hard disk drive (HDD) installed in it may be stolen. If the edge computer or its HDD is stolen, the cache data, i.e., the original data stored in the cloud server, may be leaked.

As a technique for preventing the leakage, secret sharing is known by which an electronic document (file data) is encoded and divided into multiple encoded data items and distributed into different servers.

Related techniques are disclosed in, for example, Japanese Laid-open Patent Publication No. 2008-198016 and Japanese Laid-open Patent Publication No. 2008-152593.

However, even if the file data is divided into the multiple encoded data items, when the terminal uses the file data, the file data must be decoded from the encoded data items and exist in the terminal. Thus, if the file data is not immediately used and the terminal is left unused, the terminal may be stolen and the file data may be leaked. To prevent the leakage, the file data should be transmitted to the terminal immediately before the use of the file data. However, since a communication load is large, it takes time to completely transmit the file data. Therefore, a time period before the file data becomes available may be long and the convenience of users may be reduced.

### SUMMARY

According to an aspect of the embodiments, an information processing device includes a memory; and a processor coupled to the memory and the processor configured to: acquire file data to be used by a terminal; generate multiple tallies from the file data; transmit at least one tally among the multiple tallies to an external device; generate attribute information including information of the file data and information of the external device; transmit, to the terminal, the generated attribute information and the multiple tallies except for the at least one tally transmitted to the external device; and transmit the attribute information to the external device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of a distributed processing system according to a first embodiment;

FIG. 2A is a diagram illustrating a hardware configuration of an edge computer;

FIG. 2B is a diagram illustrating a hardware configuration of each of a remote computer and a terminal;

FIG. 3 is a diagram illustrating functional configurations of the edge computer, the remote computer, and the terminal according to the first embodiment;

FIG. 4A is a diagram illustrating a file information table;

FIG. 4B is a diagram illustrating an example of metadata;

FIG. 5 is a flowchart illustrating processing by the edge computer in an advance preparation;

FIG. 6 is a flowchart illustrating processing by the remote computer in the advance preparation;

FIG. 7 is a diagram illustrating data exchange in the advance preparation;

FIG. 8 is a flowchart illustrating processing by the edge computer in a terminal coupling process;

FIG. 9 is a flowchart illustrating processing by the remote computer in the terminal coupling process;

FIG. 10 is a flowchart illustrating processing by the terminal in the terminal coupling process;

FIG. 11 is a diagram illustrating data exchange in the terminal coupling process;

FIG. 12 is a flowchart illustrating processing by the edge computer in a terminal detection process;

FIG. 13 is a flowchart illustrating processing by the terminal in a file usage process;

FIG. 14 is a flowchart illustrating processing by the remote computer in the file usage process;

FIG. 15 is a diagram illustrating data exchange in the file usage process;

FIG. 16 is a diagram illustrating functional configurations of an edge computer, a remote computer, and a terminal according to a second embodiment;

FIG. 17 is a diagram illustrating data exchange in an advance preparation according to the second embodiment;

FIG. 18 is a diagram illustrating data exchange in a terminal coupling process according to the second embodiment; and

FIG. 19 is a diagram illustrating data exchange in a file usage process according to the second embodiment.

### DESCRIPTION OF EMBODIMENTS

### First Embodiment

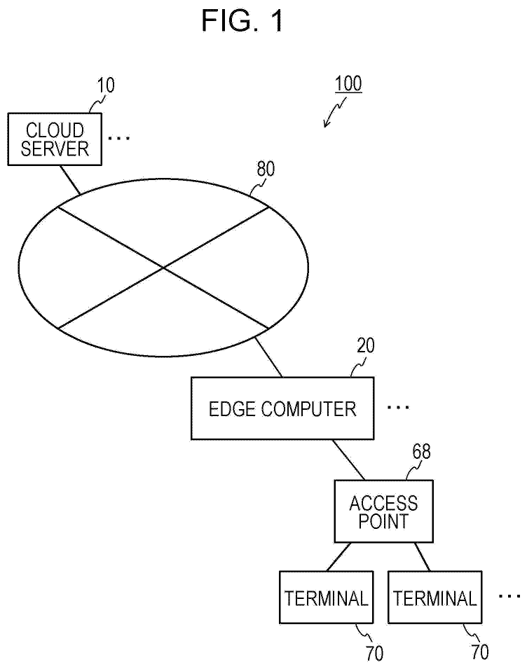

A first embodiment of a distributed processing system is described below in detail with reference to FIGS. 1 to 15.

FIG. 1 illustrates a configuration of a distributed processing system 100 according to the first embodiment. As illustrated in FIG. 1, the distributed processing system 100 includes at least one cloud server 10 coupled to a network 80, and at least one edge computer 20. As the network 80, a wired or wireless communication network of any type, such as the Internet, a local area network (LAN), or a virtual private network (VPN), may be used. Communication to be executed via the network 80 may be encrypted by, for example, Transport Layer Security (TLS)/Secure Sockets Layer (SSL) or other protocols.

The cloud server 10 is an information processing device installed in a data center or other facilities and holds data for users in a company. The edge computer 20 is, for example, an information processing device installed in each of rooms (e.g., meeting room) in the company. A terminal 70 authenticated by the edge computer 20 is permitted to communicate with the edge computer 20 via an access point 68. Thus, the terminal 70 is permitted to use data held in the edge computer 20. The terminal 70 is a portable information processing device, such as a laptop personal computer (PC) or a tablet PC.

In the first embodiment, file data (hereinafter referred to as a “file”), such as a document to be used for a meeting, is transmitted from any of cloud servers 10 to the edge computer 20 set in the meeting room before the meeting is held in the company. The edge computer 20 executes tally generation process to generate tallies from the file. The tallies are a set of encoded information items to be used to restore the file data. The original file data may be restored by collecting all the tallies distributed to computers or some storages. Distributing the tallies generated in the same tally generation process to different locations may prevent the file from leaking even if the edge computer 20 is stolen.

When the file is used by the terminal 70, since there is some periods for which the file exists in the terminal 70, the file may be leaked if the terminal 70 is stolen. To shorten the time period for which the file exists in the terminal 70, the file should be transmitted to the terminal 70 immediately before the usage of the file. However, in this case, since a communication load increases immediately before the use of the file, a time period before the file becomes available may increase and the convenience of users may be reduced. Thus, in the first embodiment, it is important to prevent the leakage of the file while inhibiting the communication load.

In the first embodiment, a cloud server that holds the file to be used by the terminal 70, among the cloud servers 10, is referred to as a “cloud server 10a”. In the first embodiment, one of the cloud servers 10 is used as an external device (remote device) that holds at least one tally among the multiple tallies generated from the file by the edge computer 20. The one of the cloud servers 10 is referred to as a “remote computer 10b”.

The edge computer 20, the remote computer 10b, and the terminal 70 are described below in detail.

(Edge Computer 20)

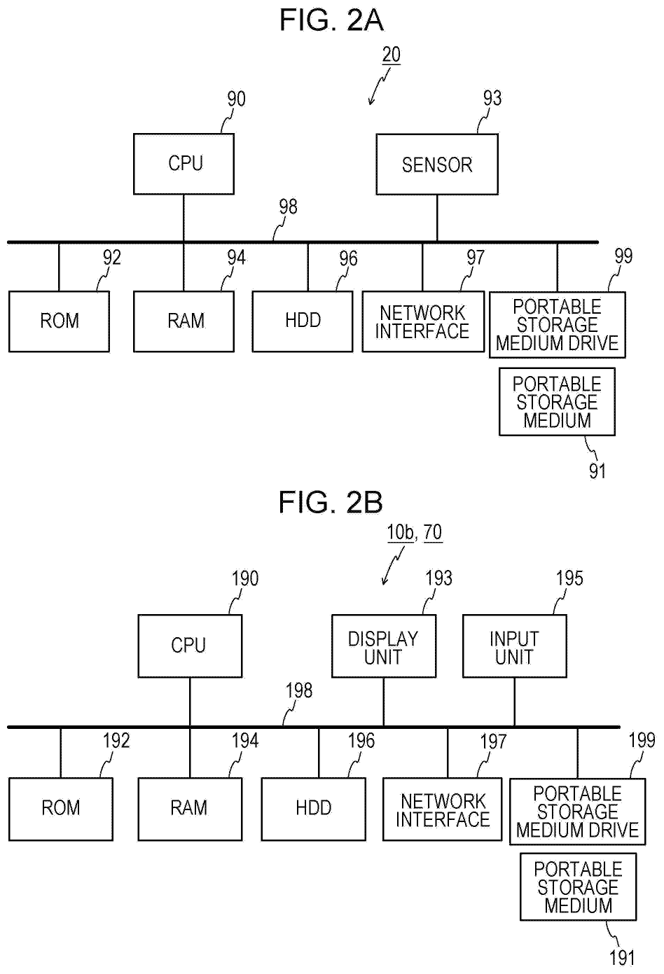

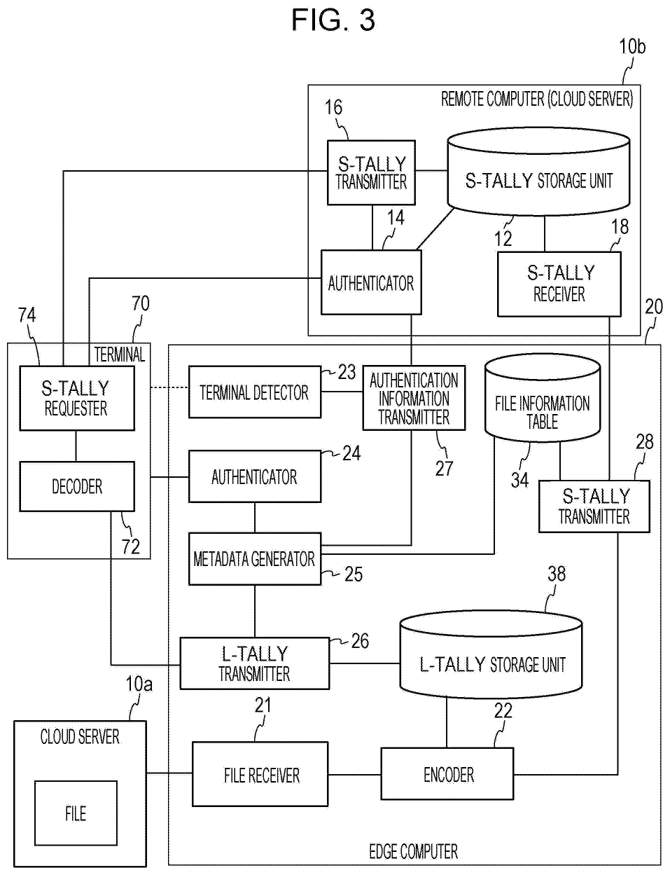

FIG. 2A illustrates a hardware configuration of the edge computer 20. As illustrated in FIG. 2A, the edge computer 20 includes a central processing unit (CPU) 90, a read-only memory (ROM) 92, a random-access memory (RAM) 94, a storage unit 96 (HDD in this case), a network interface 97, a sensor 93, and a portable storage medium drive 99. The constituent units of the edge computer 20 are coupled to a bus 98. In the edge computer 20, functions of function units that are illustrated in FIG. 3 are enabled by causing the CPU 90 to execute a program that is stored in the ROM 92 or the HDD 96 and read by the portable storage medium drive 99 from a portable storage medium 91. The functions of the function units illustrated in FIG. 3 may be enabled by an integrated circuit, such as an application specific integrated circuit (ASIC) or a field-programmable gate array (FPGA).

FIG. 3 illustrates functional configurations of the edge computer 20, the remote computer 10b, and the terminal 70. As illustrated in FIG. 3, the edge computer 20 causes the CPU 90 to execute the program, thereby operating as a file receiver 21, an encoder 22 as a tally generator, an S-tally transmitter 28 as a first transmitter, a terminal detector 23 as a detector, an authenticator 24, a metadata generator 25 as a generator, an L-tally transmitter 26, and an authentication information transmitter 27 as a third transmitter. For example, functions of an L-tally storage unit 38 are enabled by the HDD 96 illustrated in FIG. 2A.

After a file held in the cloud server 10a is transmitted from the cloud server 10a, the file receiver 21 receives the file and gives the file to the encoder 22. It is assumed that the cloud server 10a transmits the file to the edge computer 20 based on information registered by a user. The registered information includes, for example, information of the terminal that uses the file (terminal identifier (ID)), information of the user (user name), information of time when the file is used by the terminal 70 (e.g., meeting start time), and information of the file to be used (file ID and file name). Thus, the cloud server 10a transmits the file registered in the cloud server 10a to the edge computer 20 along with the information of the terminal and the user before a predetermined time when the registered file is used.

The encoder 22 executes the tally generation process for the file received by the file receiver 21. In the first embodiment, the encoder 22 executes the tally generation process, which encodes and divides the file into two types of tallies: a large tally (also referred to as L-tally) and a small tally (also referred to as S-tally). The amount of data in the large tally is larger than the amount of data in the small tally. The encoder 22 gives the large tally to the L-tally storage unit 38. The encoder 22 gives the small tally to the S-tally transmitter 28.

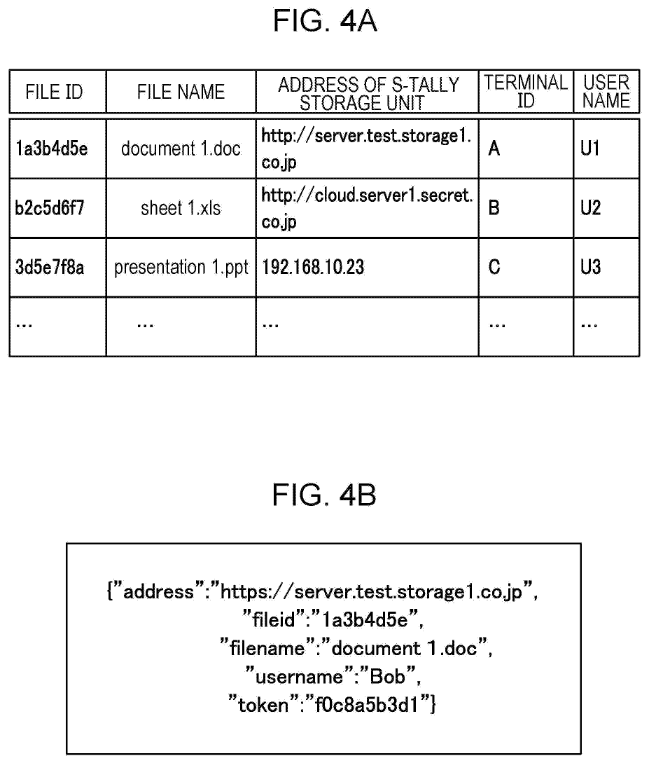

The S-tally transmitter 28 transmits the small tally to the remote computer 10b. The S-tally transmitter 28 causes an address of a storage destination (i.e., an S-tally storage unit 12 of the remote computer 10b) of the small tally, the information (file ID and file name) of the file, the information of the terminal, and the information of the user to be held in a file information table 34. The file information table 34 has a data structure as illustrated in FIG. 4A. As illustrated in FIG. 4A, the file information table 34 holds “file ID”, “file name”, “address of S-tally storage unit”, “terminal ID”, and “user name” for each file such that the “file ID”, the “file name”, the “address of S-tally storage unit”, the “terminal ID”, and the “user name” are associated with each other. A file from which a small tally is generated, a location where the small tally of the file is stored, a terminal in which the file is used, and a user who uses the file are clarified from the file information table 34 illustrated in FIG. 4A. The file name may match the file ID. In this case, either the file name or the file ID may be omitted from FIG. 4A.

Returning to FIG. 3. The terminal detector 23 monitors circumstances within a predetermined area around the edge computer 20 based on information obtained from the sensor 93 (refer to FIG. 2A). For example, the sensor 93 detects a terminal existing in the predetermined area (for example, in the meeting room). Examples of the sensor 93 include, for example, a Bluetooth (registered trademark) Low Energy (BLE) beacon, a radio frequency identifier (RFID), and a Global Positioning System (GPS) unit. The terminal detector 23 detects, in each of predetermined time periods, the terminal ID of a terminal existing in the predetermined area or the name of a user who uses the terminal. Then, the terminal detector 23 transmits results of the detection to an authenticator 14 of the remote computer 10b via the authentication information transmitter 27.

Upon receiving a login request from a user who uses the terminal 70, the authenticator 24 executes authentication on the user. For example upon receiving a user name, a password, biological information, and other information about the user from the terminal 70, the authenticator 24 crosschecks the received items with data registered for authentication, thereby executing the authentication on the user. When the authentication of the user is successful, the authenticator 24 transmits information of the user (i.e., the user name) to the metadata generator 25.

The metadata generator 25 reads information associated with the authenticated user from the file information table 34 and generates metadata (refer to FIG. 4B) based on the read information. The metadata illustrated in FIG. 4B includes, as information associated with the file used by the terminal successfully authenticated, the address (“address”) of the S-tally storage unit 12, the file ID (“fileid”), and the file name (“filename”) that have been acquired from the file information table 34. The metadata includes the user name (“username”) of the authenticated user who uses the file. The metadata also includes a token (“token”) to be used by the terminal 70 to access the remote computer 10b in order to acquire the small tally. The token is a value temporarily available to access the remote computer 10b and corresponds to a password to be used by the terminal 70 to acquire the small tally. It is assumed that the token is a character string that is randomly generated.

The metadata generator 25 transmits the generated metadata to the authenticator 14 of the remote computer 10b via the authentication information transmitter 27. The metadata generator 25 also transmits the generated metadata to the L-tally transmitter 26.

The L-tally transmitter 26 references the metadata generated by the metadata generator 25 and reads the large tally corresponding to the file described in the metadata from the L-tally storage unit 38. The L-tally transmitter 26 transmits the read large tally and the metadata to the terminal 70 that is used by the user described in the metadata.

The authentication information transmitter 27 transmits the results of the detection by the terminal detector 23 and the metadata generated by the metadata generator 25 to the authenticator 14 of the remote computer 10b.

In the first embodiment, the L-tally transmitter 26 and the authentication information transmitter 27 transmit the metadata and the large tally to the terminal 70 to enable a function as a second transmitter for transmitting the metadata to the remote computer 10b.

(Terminal 70)

Next, the terminal 70 is described. The terminal 70 has a hardware configuration as illustrated in FIG. 2B. The terminal 70 includes a CPU 190, a ROM 192, a RAM 194, a storage unit 196 (HDD in this case), a network interface 197, a display unit 193, an input unit 195, and a portable storage medium drive 199. The constituent units of the terminal 70 are coupled to a bus 198. In the terminal 70, functions of function units that are illustrated in FIG. 3 are enabled by causing the CPU 190 to execute a program that is stored in the ROM 192 or the HDD 196 and read by the portable storage medium drive 199 from a portable storage medium 191. The functions of the function units illustrated in FIG. 3 may be enabled by an integrated circuit, such as an ASIC or an FPGA, for example.

The terminal 70 causes the CPU 190 to execute the program, thereby operating as a decoder 72 and an S-tally requester 74, which are illustrated in FIG. 3. The S-tally requester 74 serves as a receiver.

Upon receiving the large tally and the metadata from the L-tally transmitter 26 of the edge computer 20, the decoder 72 gives the received metadata to the S-tally requester 74. When the S-tally requester 74 receives the small tally from the remote computer 10b, the decoder 72 to restores (decodes) the file by using the small tally and the large tally.

Upon receiving a request to use the file from the user, the S-tally requester 74 accesses the remote computer 10b by using the metadata and requests the remote computer 10b to transmit the small tally. Upon acquiring the small tally from the remote computer 10b, the S-tally requester 74 gives the acquired small tally to the decoder 72.

In the first embodiment, the decoder 72 enables functions as an acquirer for acquiring the large tally and the metadata and a restorer for restoring the file from the large tally and the small tally.

(Remote Computer 10b)

Next, the remote computer 10b is described. The remote computer 10b has a hardware configuration as illustrated in FIG. 2B, like the terminal 70. The remote computer 10b causes the CPU 190 to execute the program, thereby operating as an S-tally receiver 18, the authenticator 14, and an S-tally transmitter 16, which are illustrated in FIG. 3. Function of the S-tally storage unit 12 are enabled by the HDD 196 of the remote computer 10b.

The S-tally receiver 18 associates the small tally received from the S-tally transmitter 28 of the edge computer 20 with the file ID of the original file and causes the small tally to be stored in the S-tally storage unit 12.

The authenticator 14 causes the metadata received from the edge computer 20 to be stored in the S-tally storage unit 12. When the metadata is transmitted by the terminal 70 and reaches the authenticator 14, the authenticator 14 confirms whether the terminal 70 exists in the vicinity of the edge computer 20. The authenticator 14 confirms whether the token included in the metadata received from the terminal 70 is included in tokens included in metadata stored in the S-tally storage unit 12. The authenticator 14 executes authentication on the user based on the results of the confirmations. When the authentication is successful, the authenticator 14 transmits, to the S-tally transmitter 16, information indicating that the authentication is successful. When the authentication is failed, the authenticator 14 notifies information indicating that the authentication is failed to the S-tally requester 74 of the terminal 70.

Upon receiving, from the authenticator 14, the information indicating that the authentication is successful, the S-tally transmitter 16 acquires, from the S-tally storage unit 12, the small tally corresponding to the file ID described in the metadata received from the terminal 70 and transmits the acquired small tally to the S-tally requester 74 of the terminal 70.

(Processes of Distributed Processing System 100)

Next, processes of the distributed processing system 100 are described in detail with reference to flowcharts and other drawings.

In the first embodiment, “advance preparation”, a “terminal coupling process”, a “terminal detection process”, and a “file usage process” are executed. The processes are described below.

(Advance Preparation)

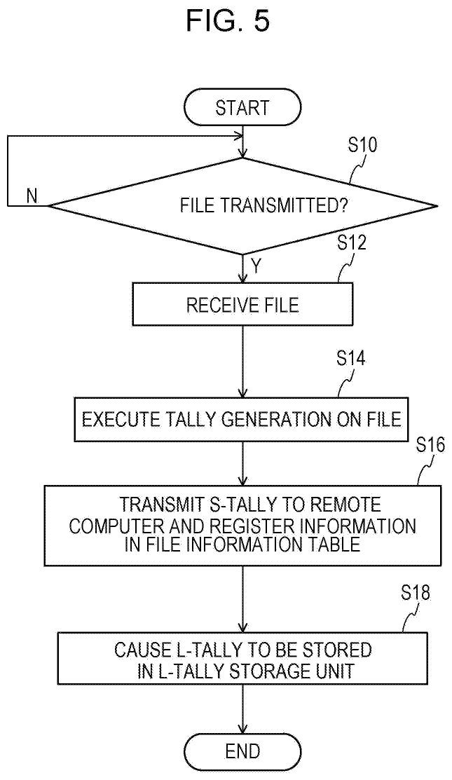

First, the advance preparation is described with reference to flowcharts of FIGS. 5 and 6 and FIG. 7.

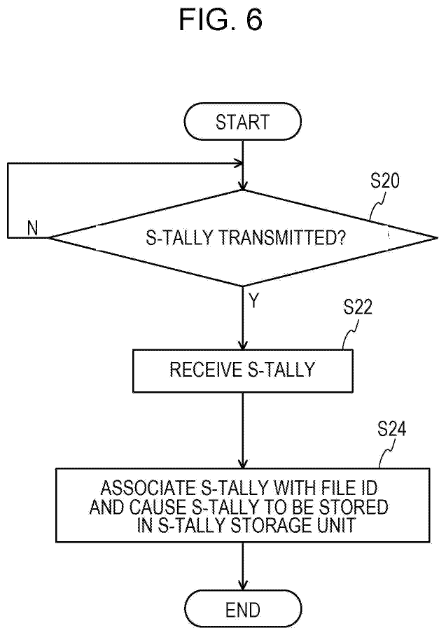

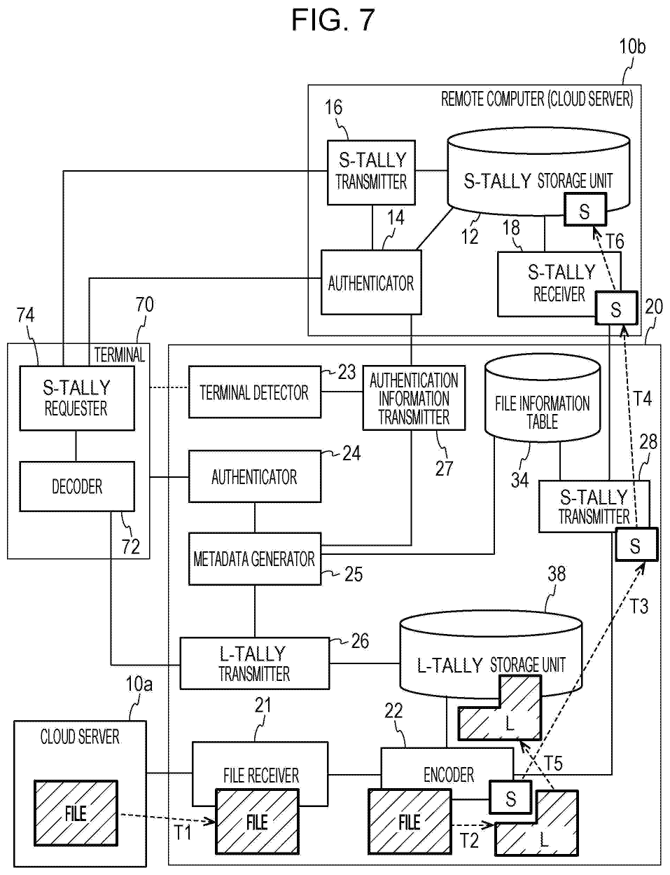

In the advance preparation, the edge computer 20 executes processing in accordance with the flowchart of FIG. 5 and the remote computer 10b executes processing in accordance with the flowchart of FIG. 6. FIG. 7 illustrates data exchange in the advance preparation.

In the processing of FIG. 5, in step S10, the file receiver 21 of the edge computer 20 stands by until a file is transmitted by the cloud server 10a and reaches the file receiver 21. The cloud server 10a transmits the file to be used for a meeting to the edge computer 20 at a predetermined time (for example, a time when the meeting starts). When the file is transmitted by the cloud server 10a and reaches the file receiver 21, the processing proceeds to step S12 and the file receiver 21 receives the transmitted file (refer to T1 in FIG. 7). In this case, the file receiver 21 also receives information of a terminal and information of a user who uses the file. Then, the file receiver 21 gives the received file to the encoder 22.

In step S14, the encoder 22 executes the tally generation on the file to generate tallies from the file (refer to T2 in FIG. 7). In this case, it is assumed that two tallies (large tally and small tally) are generated by the tally generation. The encoder 22 gives the small tally to the S-tally transmitter 28 (refer to T3 in FIG. 7).

In step S16, the S-tally transmitter 28 transmits the small tally to the remote computer 10b (refer to T4 in FIG. 7). When the S-tally transmitter 28 transmits the small tally, the S-tally transmitter 28 registers information of the file in the file information table 34. For example, it is assumed that the file ID of the original file of the small tally is “1a3b4d5e”, the file name is “document1.doc”, an address of the remote computer 10b at which the small tally is stored is “http://server.test.storage1.co.jp/”, the terminal ID of the terminal 70 that uses the file is “A”, and the user name of the user who uses the file is “U1”. In this case, information described in the first row from the top of FIG. 4A is held in the file information table 34.

In step S18, the encoder 22 causes the large tally to be stored in the L-tally storage unit 38 (refer to T5 in FIG. 7). Then, the processing by the edge computer 20 in the advance preparation is terminated.

In the processing of FIG. 6, in step S20, the S-tally receiver 18 of the remote computer 10b stands by until the small tally is transmitted by the S-tally transmitter 28 of the edge computer 20 and reaches the S-tally receiver 18. Thus, the S-tally receiver 18 causes the processing to proceed to step S22 when step S16 illustrated in FIG. 5 is executed in the edge computer 20.

In step S22, the S-tally receiver 18 receives the small tally (refer to T4 in FIG. 7).

In step S24, the S-tally receiver 18 associates the received small tally with the file ID of the original file and causes the small tally to be stored in the S-tally storage unit 12 (refer to T6 in FIG. 7). Then, the processing by the remote computer 10b in the advance preparation is terminated. When the advance preparation is terminated, the large tally is already stored in the L-tally storage unit 38 of the edge computer 20, and the small tally is already stored in the S-tally storage unit 12 of the remote computer 10b. As described above, in the first embodiment, the large tally and the small tally are stored in the storage units of the different devices. Thus, for example, even if the device storing the large tally is stolen, it is possible to prevent the file from leaking.

(Terminal Coupling Process)

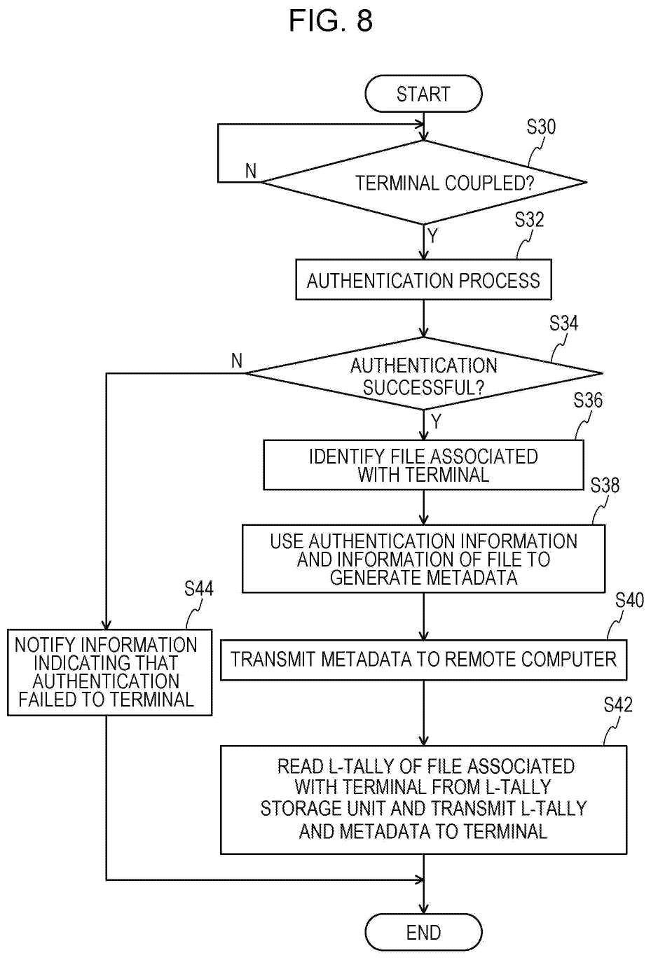

Next, the terminal coupling process is described with reference to flowcharts of FIGS. 8 to 10 and FIG. 11.

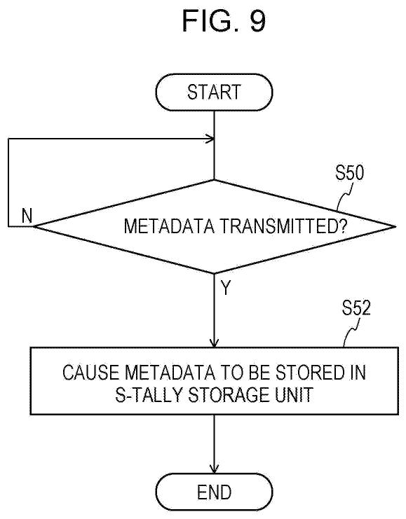

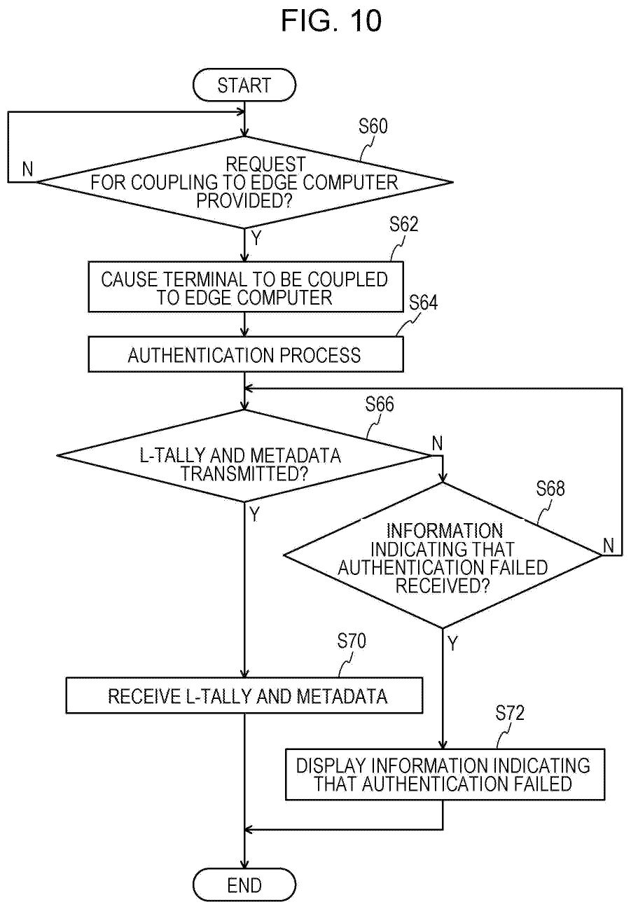

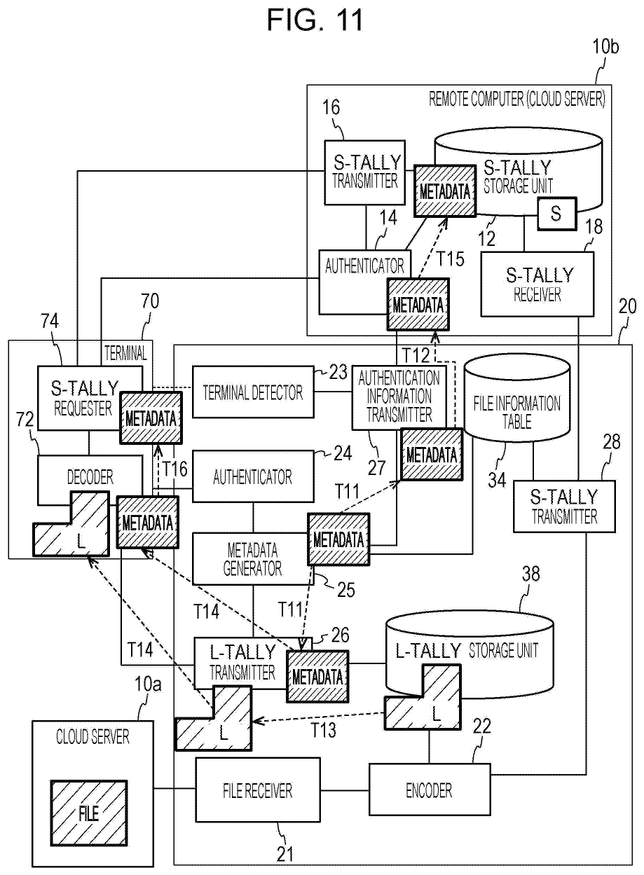

In the terminal coupling process, the edge computer 20 executes processing in accordance with the flowchart of FIG. 8, the remote computer 10b executes processing in accordance with the flowchart of FIG. 9, and the terminal 70 executes processing in accordance with the flowchart of FIG. 10. FIG. 11 illustrates data exchange in the terminal coupling process.

In the processing of FIG. 8, in step S30, the authenticator 24 of the edge computer 20 stands by until the edge computer 20 is coupled to the terminal 70. When the edge computer 20 is coupled to the terminal 70, the authenticator 24 causes the processing to proceed to step S32.

When the processing proceeds to step S32, the authenticator 24 executes an authentication process. In this case, the authenticator 24 executes authentication using the user name, the password, the biological information, and other information about the user, which are input by the user into the terminal 70.

In step S34, the authenticator 24 determines whether the authentication by the authenticator 24 is successful. When the result of the determination of step S34 is positive, the processing proceeds to step S36 and the metadata generator 25 references the file information table 34 (FIG. 4A) and identifies the file (file used by the terminal 70) associated with the terminal 70.

In step S38, the metadata generator 25 generates metadata by using authentication information (user name) and information of the file. For example, when the file ID of the file identified in step S36 is “1a3b4d5e”, the metadata generator 25 generates metadata illustrated in FIG. 4B based on the information described in the first row illustrated in FIG. 4A. The metadata generator 25 gives the generated metadata to the authentication information transmitter 27 and the L-tally transmitter 26 (refer to T11 in FIG. 11).

In step S40, the authentication information transmitter 27 transmits the metadata generated in step S38 to the authenticator 14 of the remote computer 10b (refer to T12 in FIG. 11).

In step S42, the L-tally transmitter 26 reads, from the L-tally storage unit 38, the large tally of the file described in the metadata (refer to T13 in FIG. 11) and transmits the large tally and the metadata to the decoder 72 of the terminal 70 (refer to T14 in FIG. 11). Then, the processing by the edge computer 20 in the terminal coupling process is terminated.

When the authenticator 24 determines that the authentication is failed in step S34, the result of the determination of step S34 is negative and the processing proceeds to step S44.

When the processing proceeds to step S44, the authenticator 24 notifies information indicating that the authentication is failed to the terminal 70. Then, the processing by the edge computer 20 in the terminal coupling process is terminated.

While the processing of FIG. 8 is executed by the edge computer 20 as described above, the processing according to the flowchart of FIG. 9 is executed by the remote computer 10b.

In the processing of FIG. 9, in step S50, the authenticator 14 of the remote computer 10b stands by until the metadata is transmitted by the authentication information transmitter 27 of the edge computer 20 and reaches the authenticator 14. When the metadata is transmitted and reaches the authenticator 14, the authenticator 14 causes the processing to proceed to step S52 and causes the metadata to be stored in the S-tally storage unit 12 (refer to T15 in FIG. 11). Then, the processing by the remote computer 10b in the terminal coupling process is terminated.

While the processing of FIGS. 8 and 9 is executed by the edge computer 20 and the remote computer 10b as described above, the processing according to the flowchart of FIG. 10 is executed by the terminal 70.

In the processing of FIG. 10, in step S60, a controller (not illustrated) of the terminal 70 waits until the controller receives, from the user, a request for coupling to the edge computer 20. Upon receiving the request from the user, the controller causes the processing to proceed to step S62 to couple the terminal 70 to the edge computer 20. In step S64, the controller executes an authentication process. In the authentication process, the controller transmits, to the authenticator 24 of the edge computer 20, the user name, the password, the biological information, and other information about the user, which are input by the user to the terminal 70.

In step S66 and S68, the decoder 72 stands by until either the large tally and the metadata are transmitted by the L-tally transmitter 26 of the edge computer 20 and reach the decoder 72 (step S66) or information indicating that the authentication is failed is transmitted and reaches the decoder 72 (step S68). When the large tally and the metadata are transmitted and reach the decoder 72, the result of the determination of step S66 is positive and the decoder 72 causes the processing to proceed to step S70.

When the processing proceeds to step S70, the decoder 72 receives the transmitted large tally and the transmitted metadata. The decoder 72 gives the received metadata to the S-tally requester 74 (refer to T16 in FIG. 11). Then, the processing by the terminal 70 in the terminal coupling process is terminated.

When the information indicating that the authentication is failed is transmitted and reaches the decoder 72 while the decoder 72 stands by in step S66 and S68, the result of the determination of step S68 is positive and the decoder 72 causes the processing to proceed to step S72. In this case, the decoder 72 causes the display unit 193 to display the information indicating that the authentication is failed, and the processing by the terminal 70 in the terminal coupling process is terminated.

In the first embodiment, since the above-described terminal coupling process is executed, the large tally with a large amount of data is transmitted in advance to the terminal 70 that uses the file.

(Terminal Detection Process)

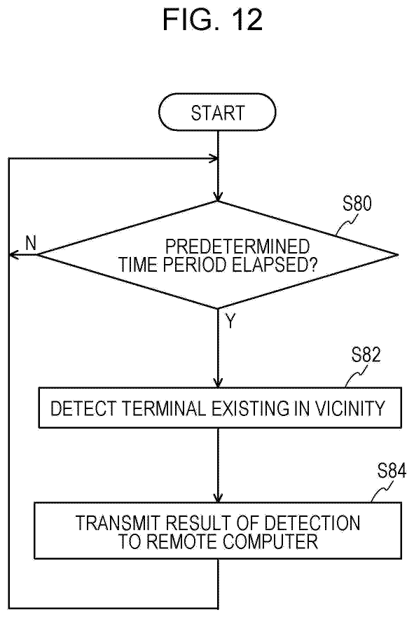

Next, the terminal detection process is described with reference to a flowchart of FIG. 12. In the terminal detection process, the edge computer 20 executes processing in accordance with the flowchart of FIG. 12

In the processing of FIG. 12, in step S80, the terminal detector 23 of the edge computer 20 stands by until a predetermined time period elapses. When the predetermined time period elapses, the processing proceeds to step S82.

When the processing proceeds to step S82, the terminal detector 23 detects a terminal existing in the vicinity of the edge computer 20 (for example, in the meeting room) by using the sensor 93.

In step S84, the terminal detector 23 transmits information of the detected terminal to the authenticator 14 of the remote computer 10b via the authentication information transmitter 27. The information of the detected terminal is a terminal ID of the detected terminal or the user name of a user who uses the detected terminal. Then, the processing returns to step S80 to repeatedly execute steps S82 and S84 in each of the predetermined time periods.

(File Usage Process)

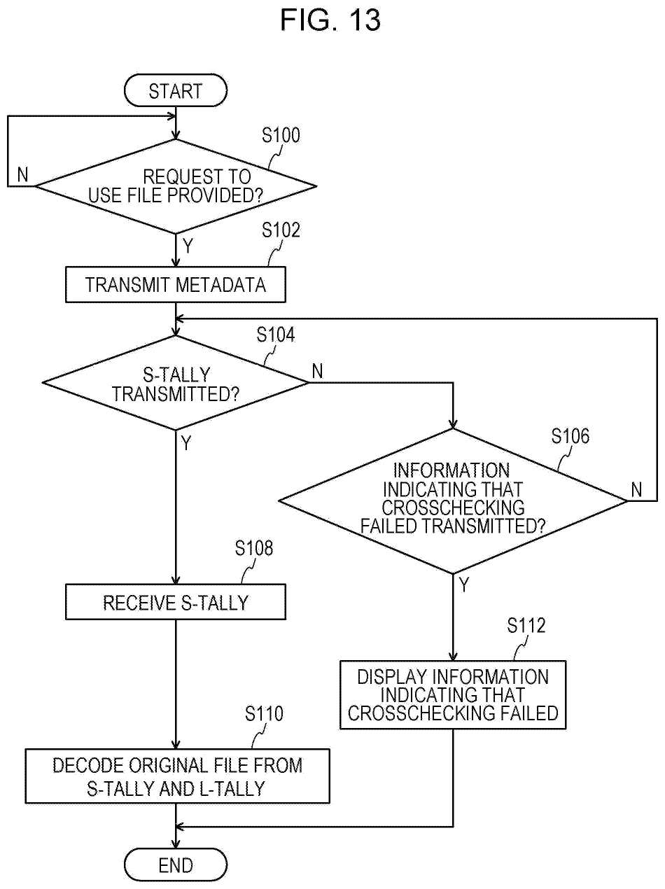

Next, the file usage process is described with reference to flowcharts of FIGS. 13 and 14 and FIG. 15.

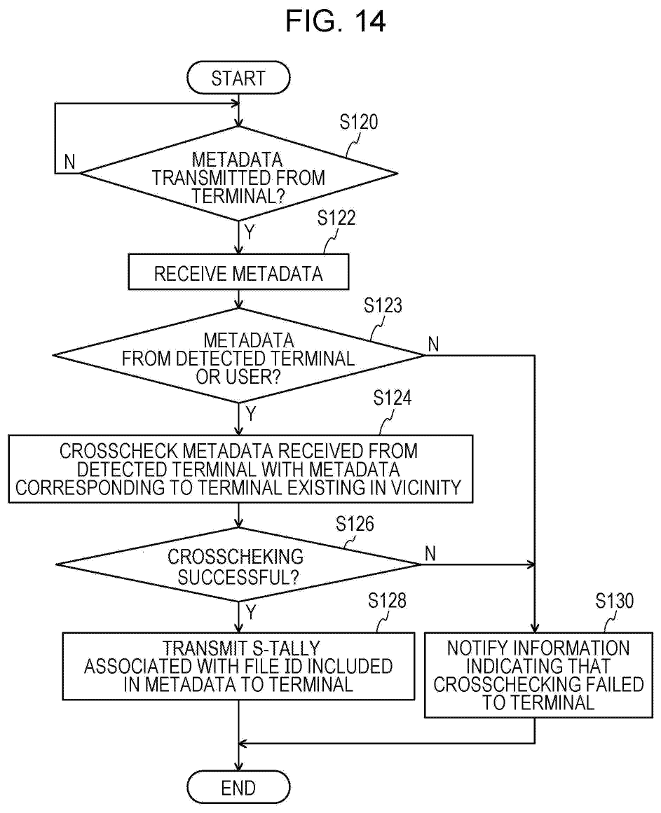

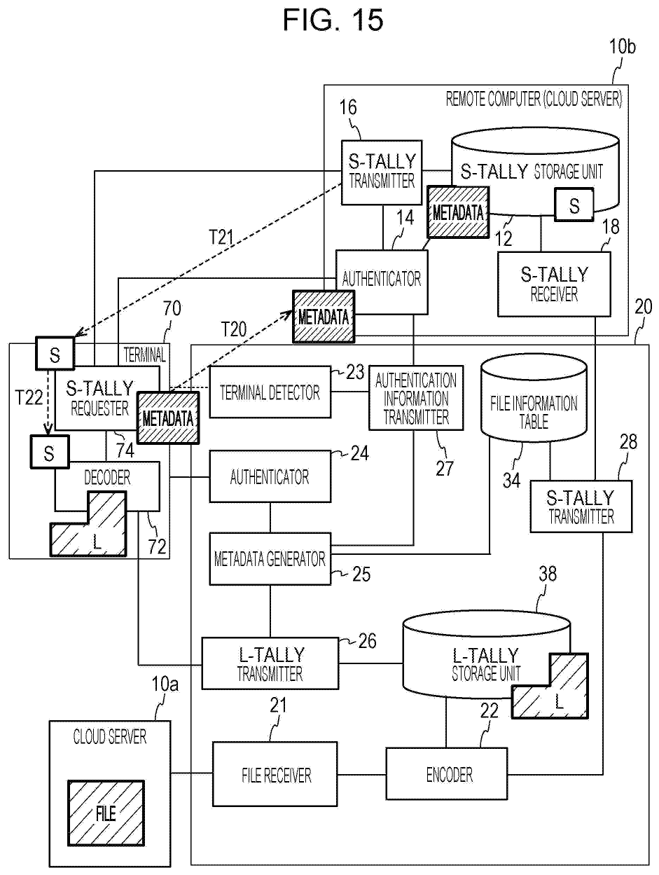

In the file usage process, the terminal 70 executes processing in accordance with the flowchart of FIG. 13 and the remote computer 10b executes processing in accordance with the flowchart of FIG. 14. FIG. 15 illustrates data exchange in the file usage process.

In the processing of FIG. 13, in step S100, the S-tally requester 74 of the terminal 70 stands by until a request to use the file is input by the user to the terminal 70. When the user inputs the request to use the file to the terminal 70, the S-tally requester 74 causes the processing to proceed to step S102 to transmit the metadata to the authenticator 14 of the remote computer 10b (refer to T20 in FIG. 15).

In the processing of FIG. 14, in step S120, the authenticator 14 of the remote computer 10b stands by until the metadata is transmitted by the terminal 70 and reaches the authenticator 14. When step S102 illustrated in FIG. 13 is executed by the terminal 70, the authenticator 14 causes the processing to proceed to step S122.

In step S122, the authenticator 14 receives the transmitted metadata. In step S123, the authenticator 14 determines whether the authenticator 14 receives the metadata from the terminal detected by the terminal detector 23 immediately before, or from the user of the terminal. When the result of the determination of step S123 is positive, the processing proceeds to step S124 and the authenticator 14 crosschecks the token included in the received metadata with the tokens included in the metadata stored in the S-tally storage unit 12. In step S126, the authenticator 14 determines whether the crosschecking is successful. When the result of the determination of step S126 is positive, the authenticator 14 causes the processing to proceed to step S128. When the processing proceeds to step S128, the authenticator 14 provides an instruction to the S-tally transmitter 16, to read the small tally corresponding to the file ID included in the metadata from the S-tally storage unit 12, and transmit the small tally to the terminal 70 (refer to T21 in FIG. 15). When the result of the determination of step S123 or S126 is negative, the authenticator 14 proceeds the processing to S130 to notify information indicating that the crosschecking is failed to the S-tally requester 74 of the terminal 70. After step S128 or S130 is executed, the processing by the remote computer 10b in the file usage process is terminated.

After step S102 illustrated in FIG. 13 is executed by the S-tally requester 74 of the terminal 70, the S-tally requester 74 stands by until the small tally is transmitted and reaches the S-tally requester 74 in step S104 or until the information indicating that the crosschecking is failed is transmitted and reaches the S-tally requester 74 in step S106. When the small tally is transmitted and reaches the S-tally requester 74, the result of the determination of step S104 is positive and the S-tally requester 74 causes the processing to proceed to step S108. When the processing proceeds to step S108, the S-tally requester 74 receives the transmitted small tally. In this case, the S-tally requester 74 gives the received small tally to the decoder 72 (refer to T22 in FIG. 15).

In step S110, the decoder 72 decodes (restores) the original file from the small tally and the large tally. Accordingly, the file is available to the user of the terminal 70. In this case, since the terminal 70 receives only the small tally with a small amount of data immediately before using the file, the communication load of the terminal 70 immediately before the use of the file may be reduced.

When the information indicating that the crosschecking is failed is transmitted and reaches the S-tally requester 74 while the S-tally requester 74 stands by in step S104 and S106, the result of the determination of step S106 is positive. In this case, the S-tally requester 74 causes the processing to proceed to step S112. When the processing proceeds to step S112, the S-tally requester 74 causes the display unit 193 of the terminal 70 to display the information indicating that the crosschecking is failed.

After step S110 or S112 is executed, the processing by the terminal 70 in the file usage process is terminated.

The above-described processes (flowcharts) are repeatedly executed even after the processes are terminated (ended).

As described above in detail, according to the first embodiment, the edge computer 20 includes the encoder 22 and the S-tally transmitter 28. The encoder 22 acquires the file to be used by the terminal 70 and generates the large tally and the small tally from the file. The S-tally transmitter 28 transmits the small tally to the remote computer 10b. The edge computer 20 also includes the metadata generator 25, the L-tally transmitter 26, and the authentication information transmitter 27. The metadata generator 25 generates the metadata including the information of the file and the information of the storage destination of the small tally. The L-tally transmitter 26 transmits the generated metadata and the large tally to the terminal 70. The authentication information transmitter 27 transmits the metadata to the remote computer 10b. In the first embodiment, the large tally and the small tally are held in the different devices. Thus, even if any of the devices is stolen, it is possible to prevent the file from leaking. The terminal 70 to which the large tally has been transmitted in advance acquires the small tally from the remote computer 10b by using the metadata to decode the file. Thus, after the terminal 70 acquires the small tally immediately before using the file, the file becomes available to the terminal 70. In this case, it is sufficient if the terminal 70 acquires the small tally with a small amount of data immediately before using the file. Thus, even when the file has a large amount of data, the communication load immediately before the use of the file may be reduced. Thus, since it is possible to shorten a waiting period between the time when a request to use the file is provided by the user and the time when the file becomes available, the convenience of users may be improved.

In the first embodiment, the decoder 72 of the terminal 70 acquires the large tally and the metadata from the edge computer 20. When a request to use the file is provided by the user, the S-tally requester 74 accesses the remote computer 10b by using the metadata to receive the small tally. Then, the decoder 72 restores the file from the large tally and the small tally. In this case, since the terminal 70 decodes the file by using the small tally received immediately before the use of the file, it is possible to shorten a time period for which the file exists in the terminal 70 and the file is not used. Thus, it is possible to prevent the leakage of the file. In the first embodiment, since the decoder 72 of the terminal 70 restores the file by using the large tally and the small tally, the edge computer 20 does not need to restore the file. This may reduce a load of the edge computer 20.

According to the first embodiment, the metadata includes the token that indicates authentication information to be used to authenticate the terminal 70 in the remote computer 10b. Thus, the acquisition of the small tally by a malicious third party who impersonates the user may be prevented.

According to the first embodiment, the edge computer 20 includes the terminal detector 23 that detects a terminal existing in the vicinity of the edge computer 20, and the authentication information transmitter 27 transmits a result of the detection by the terminal detector 23 to the remote computer 10b. Upon receiving metadata from the terminal existing in the vicinity of the edge computer 20, the remote computer 10b executes authentication using the metadata. This may prevent the small tally from being transmitted to a terminal not existing in the vicinity of the edge computer 20 (for example, a terminal not existing in the meeting room). Thus, security may be improved.

In the first embodiment, since the small tally is stored in the S-tally storage unit 12 of the remote computer 10b, the remote computer 10b transmits the small tally with a small amount of data to the terminal immediately before the use of the file. This may reduce the communication load, compared to the case where the edge computer 20 transmits the large tally to the terminal immediately before the use of the file.

Although the first embodiment describes the case where the small tally is transmitted to the remote computer 10b, the first embodiment is not limited to this. For example, the large tally may be transmitted to the remote computer 10b.

Although the first embodiment describes the case where the encoder 22 generates the two tallies from the file in the tally generation, the first embodiment is not limited to this. For example, the encoder 22 may generate three or more tallies from the file in the tally generation. In this case, one or multiple tallies among the generated tallies may be transmitted to the remote computer 10b. Multiple tallies among the generated tallies may be transmitted to different remote computers. In this case, the metadata generator 25 may generate metadata corresponding to the multiple tallies and transmit the metadata to the terminal 70.

### Second Embodiment

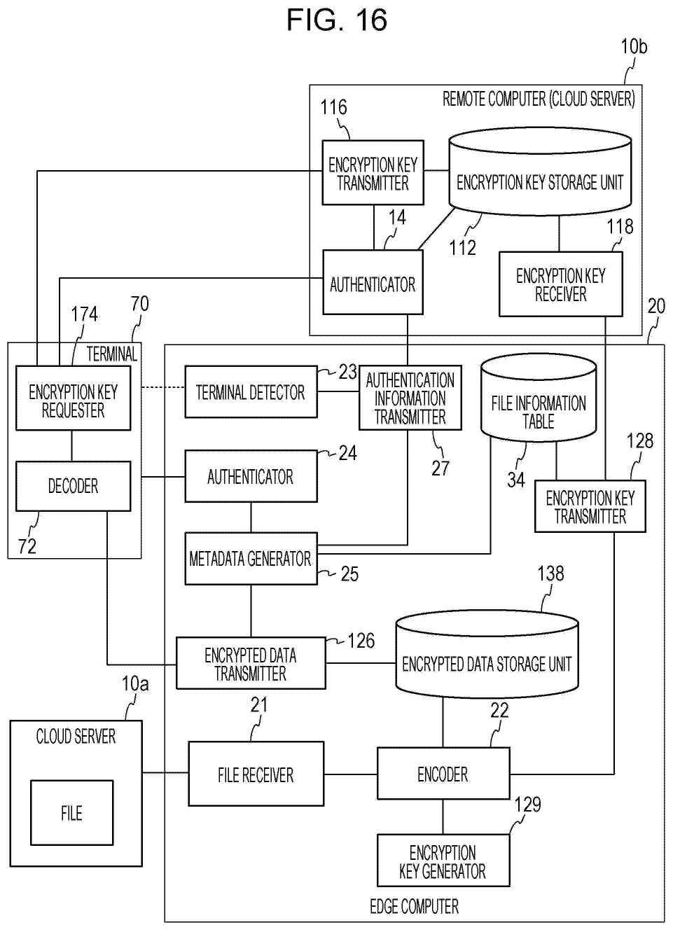

Next, a second embodiment is described with reference to FIGS. 16 to 19. In the first embodiment, the encoder 22 executes the tally generation on the file to generate the small tally and the large tally. In the second embodiment, the encoder 22 generates encrypted data from the file by using an encryption key and uses the encrypted data and the encryption key as tallies.

Functions of devices that are different from the functions described in the first embodiment are mainly described below using functional configurations illustrated in FIG. 16.

An edge computer 20 according to the second embodiment includes an encryption key generator 129, as illustrated in FIG. 16. The edge computer 20 according to the second embodiment also includes an encrypted data transmitter 126, an encryption key transmitter 128 as the first transmitter, and an encrypted data storage unit 138, instead of the L-tally transmitter 26, the S-tally transmitter 28, and the L-tally storage unit 38, respectively, which are described in the first embodiment.

A terminal 70 according to the second embodiment includes an encryption key requester 174 as the receiver, instead of the S-tally requester 74 described in the first embodiment. A remote computer 10b according to the second embodiment also includes an encryption key storage unit 112, an encryption key transmitter 116, and an encryption key receiver 118, instead of the S-tally storage unit 12, the S-tally transmitter 16, and the S-tally receiver 18, respectively, which are described in the first embodiment.

Processes according to the second embodiment that are “advance preparation”, a “terminal coupling process”, a “terminal detection process”, and a “file usage process” are described below.

(Advance Preparation)

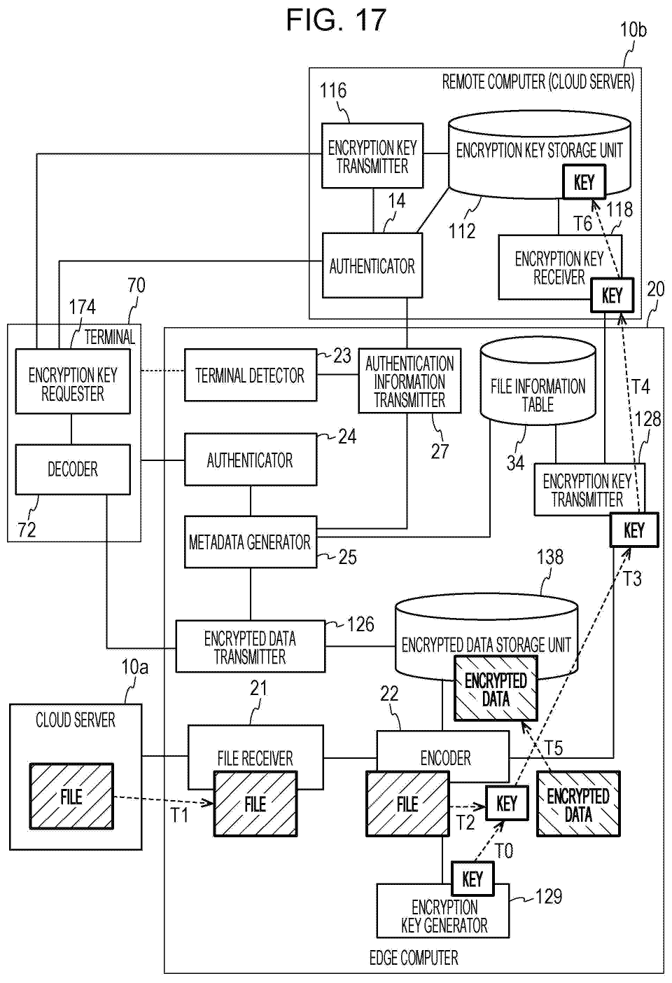

In the second embodiment, a process illustrated in FIG. 17 is executed in the advance preparation. As illustrated in FIG. 17, when the file receiver 21 receives a file transmitted by the cloud server 10a (refer to T1 in FIG. 17), the encryption key generator 129 generates an encryption key and gives the generated encryption key to the encoder 22 (refer to T0 in FIG. 17). The encoder 22 encrypts the file using the encryption key and generates encrypted data (refer to T2 in FIG. 17). Then, the encoder 22 gives the encryption key to the encryption key transmitter 128 (refer to T3 in FIG. 17). The encoder 22 causes the encrypted data to be stored in the encrypted data storage unit 138 (refer to T5 in FIG. 17).

Then, the encryption key transmitter 128 transmits the encryption key to the encryption key receiver 118 of the remote computer 10b (refer to T4 in FIG. 17). The encryption key receiver 118 associates the encryption key with the file ID and causes the encryption key to be stored in the encryption key storage unit 112 (refer to T6 in FIG. 17).

Then, the processing by the remote computer 10b in the advance preparation is terminated. When the advance preparation is terminated, the encrypted data is already stored in the encrypted data storage unit 138 of the edge computer 20 and the encryption key is already stored in the encryption key storage unit 112 of the remote computer 10b. In the second embodiment, the encrypted data and the encryption key are stored in the storage units of the different devices. Thus, for example, even if the device storing the encrypted data is stolen, it is possible to prevent the file from leaking.

(Terminal Coupling Process)

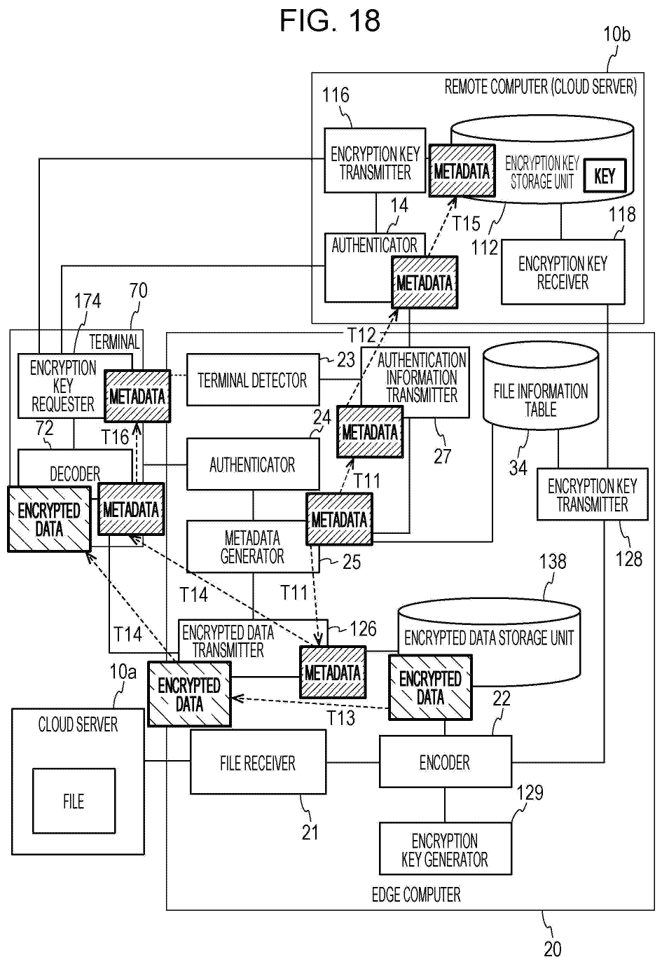

As is apparent from the comparison of FIG. 18 with FIG. 11, the terminal coupling process according to the second embodiment is the same as or similar to the terminal coupling process described in the first embodiment, except that the encrypted data transmitter 126 transmits the encrypted data to the terminal 70 (refer to T13 and T14 in FIG. 18).

(Terminal Detection Process)

The terminal detection process according to the second embodiment is the same as or similar to the terminal detection process described in the first embodiment.

(File Usage Process)

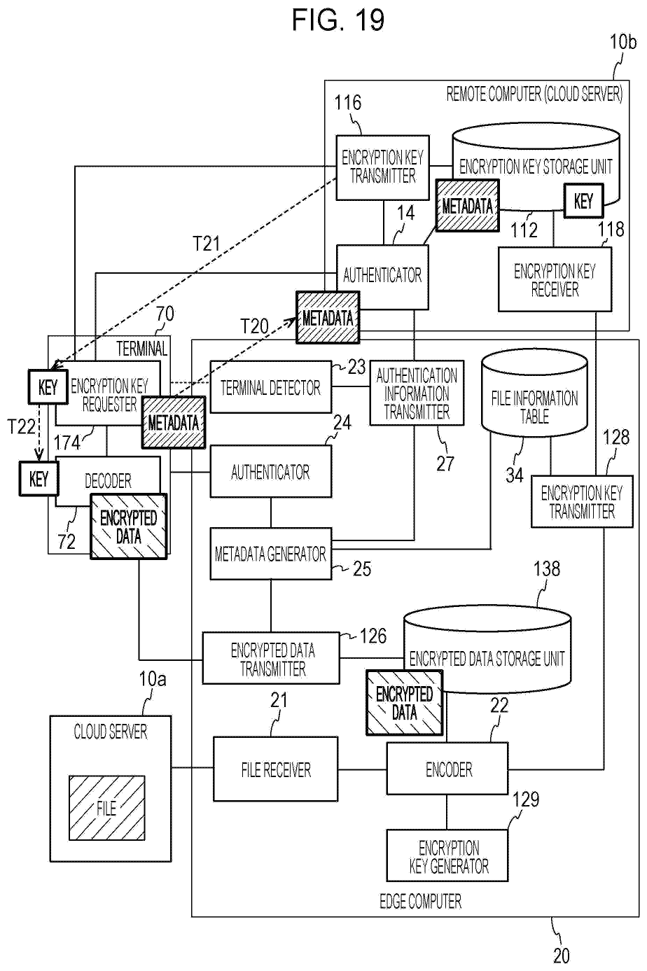

As illustrated in FIG. 19, in the file usage process, the encryption key requester 174 accesses the remote computer 10b by using the metadata and requests the remote computer 10b to transmit the encryption key (refer to T20 in FIG. 19). When authentication by the authenticator 14 of the remote computer 10b using the metadata is successful, the encryption key transmitter 116 transmits the encryption key to the encryption key requester 174 of the terminal 70 (refer to T21 in FIG. 19). Then, the encryption key requester 174 gives the encryption key to the decoder 72 (refer to T22 in FIG. 19). The decoder 72 uses the encryption key to decrypt the encrypted data and generate the file.

In the flowcharts of FIGS. 5, 6, 8 to 10, and 12 to 14, it is assumed that the “small tally”, the “large tally”, and the “tally generation” are interpreted as the “encryption key”, the “encrypted data”, and the “encryption”. It is assumed that the encryption key generator 129 generates the encryption key between steps S12 and S14 illustrated in FIG. 5. However, the encryption key generator 129 may generate the encryption key before step S12.

As is apparent from the above description, in the second embodiment, the encrypted data transmitter 126 and the authentication information transmitter 27 transmit the metadata and the encrypted data to the terminal 70 and enable functions as the second transmitter for transmitting the metadata to the remote computer 10b. The decoder 72 enables functions as an acquirer for acquiring the encrypted data and the metadata and a decryptor for decrypting the encrypted data to the file by using the encryption key.

According to the second embodiment, the edge computer 20 includes the encoder 22 that acquires the file to be used by the terminal 70 and uses the encryption key to generate the encrypted data, and the encryption key transmitter 128 that transmits the encryption key to the remote computer 10b. The edge computer 20 also includes the metadata generator 25 that generates the metadata including the information of the file and the information of the storage destination of the encryption key, the encrypted data transmitter 126 that transmits the generated metadata and the encrypted data to the terminal 70, and the authentication information transmitter 27 that transmits the metadata to the remote computer 10b. In the second embodiment, the encryption key and the encrypted data are held in the different devices. Thus, even if any of the devices is stolen, it is possible to prevent the file from leaking. The terminal 70 to which the encrypted data has been transmitted in advance acquires the encryption key from the remote computer 10b by using the metadata. Thereafter, the terminal 70 may decode (decrypt) the encrypted data to the file. Thus, after the terminal 70 acquires the encryption key immediately before using the file, the file becomes available to the terminal 70. It is sufficient that the terminal 70 acquires the encryption key with a small amount of data immediately before using the file. Thus, even when the file has a large amount of data, the communication load immediately before the use of the file may be reduced. Since it is possible to shorten a waiting period between the time when the user provides a request to use the file and the time when the file becomes available, the convenience of users may be improved.

In the second embodiment, the decoder 72 of the terminal 70 acquires the encrypted data and the metadata from the edge computer 20. When a request to use the file is provided from the user, the encryption key requester 174 accesses the remote computer 10b by using the metadata to receive the encryption key. Then, the decoder 72 decrypts the encrypted data into the file by using the encryption key. Since the terminal 70 decrypts the encrypted data into the file by using the encryption key received immediately before the user uses the file, it is possible to shorten a time period for which the file exists in the terminal 70 and the file is not used. It is, therefore, possible to prevent the leakage of the file. In the second embodiment, since the decoder 72 of the terminal 70 decrypts the encrypted data, the edge computer 20 does not need to decrypt the encrypted data. This may reduce the load of the edge computer 20.

Although the second embodiment describes the case where the edge computer 20 transmits the encrypted data to the terminal 70 in advance and the encryption key is stored in the remote computer 10b, the second embodiment is not limited to this. For example, the edge computer 20 may transmit the encryption key to the terminal 70 in advance and the encrypted data may be stored in the remote computer 10b.

Although the embodiments describe the case where the authenticator 14 determines whether the terminal 70 exists in the vicinity of the edge computer 20 before the authenticator 14 executes the authentication, the embodiments are not limited to this. For example, the authenticator 14 may execute the authentication regardless of whether the terminal 70 exists in the vicinity of the edge computer 20. In this case, the edge computer 20 does not need to include the terminal detector 23.

Although the embodiments describe the case where the distributed processing system 100 is used in the company, the embodiments are not limited to this. For example, the distributed processing system 100 may be used in a school or other public facilities. In the school case, the large tally or the encrypted data may be transmitted to the terminal 70 used by a teacher before the start of a class, and the terminal 70 may request the remote computer 10b to transmit the small tally or the encryption key when the teacher indicates the start of the class.

The above-described processing functions may be enabled by a computer. In that case, a program is provided, which describes the processing details of the functions that the processing devices are supposed to have is provided. The above-described processing functions are enabled in the computer by causing the computer to execute the program. The program that describes the processing details may be stored in a computer-readable storage medium (excluding a carrier wave).

To distribute the program, a portable storage medium storing the program is marketed, for example. The portable storage medium is a digital versatile disc (DVD), a compact disc read-only memory (CD-ROM), or the like. The program may be stored in a storage device of a server computer and transferred from the server computer to another computer via a network.

The computer configured to execute the program stores, in a storage device of the computer, the program stored in the portable storage medium or transferred from the server computer. Then, the computer reads the program from the storage device of the computer and executes the processes in accordance with the program. The computer may read the program directly from the portable storage medium and execute the processes in accordance with the program. Every time the program is transferred to the computer from the server computer, the computer may sequentially execute the processes in accordance with the program.

According to an aspect of the embodiments, it is possible to achieve measures against information leakage while reducing the communication load.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a memory; and
a processor coupled to the memory and the processor configured to:
acquire file data to be used by a terminal;
generate multiple tallies from the file data;
transmit at least one tally among the multiple tallies to an external device;
generate attribute information including information of the file data and information of the external device;
transmit, to the terminal, the generated attribute information and the multiple tallies except for the at least one tally transmitted to the external device; and
transmit the attribute information to the external device.

2. The information processing device according to claim 1, wherein
the attribute information includes authentication information to be used to authenticate the terminal by the external device.

3. The information processing device according to claim 1, wherein
the processor is further configured to:
detect whether the terminal exists in the vicinity of the information processing device; and
transmit a result of the detection to the external device.

4. The information processing device according to claim 1, wherein
an amount of data in the multiple tallies except for the at least one tally transmitted to the external device is larger than the amount of data in the at least one tally transmitted to the external device.

5. The information processing device according to claim 1, wherein
the processor is further configured to:
encrypt the file data by an encryption key to generate encrypted data; and
use the encrypted data and the encryption key as the multiple tallies.

6. A terminal comprising:
a memory; and
a processor coupled to the memory and the processor configured to:
acquire attribute information including information of file data and information of an external device holding at least one tally among multiple tallies generated from the file data;
acquire, from an information processing device, the multiple tallies except for the at least one tally held in the external device;
access, upon receiving a request to use the file data, the external device by using the attribute information;
receive, from the external device, the at least one tally held in the external device; and
restore the file data from the multiple tallies except for the at least one tally held in the external device acquired from the information processing device and the at least one tally held in the external device received from the external device.

7. The terminal according to claim 6, wherein
the multiple tallies are an encryption key and encrypted data that is generated by encrypting the file data by the encryption key.

8. A non-transitory computer-readable recording medium having stored therein a program that causes a computer to execute a process, the process comprising:
acquiring file data to be used by a terminal;
generating multiple tallies from the file data;
transmitting at least one tally among the multiple tallies to an external device;
generating attribute information including information of the file data and information of the external device;
transmitting, to the terminal, the generated attribute information and the multiple tallies except for the at least one tally transmitted to the external device; and
transmitting the attribute information to the external device.

9. The non-transitory computer-readable recording medium according to claim 8, wherein
the attribute information includes authentication information to be used to authenticate the terminal by the external device.

10. The non-transitory computer-readable recording medium according to claim 8, the process further comprising:
detecting whether the terminal exists in the vicinity of the information processing device; and
transmitting a result of the detection to the external device.

11. The non-transitory computer-readable recording medium according to claim 8, wherein
an amount of data in the multiple tallies except for the at least one tally transmitted to the external device is larger than an amount of data in the at least one tally transmitted to the external device.

12. The non-transitory computer-readable recording medium according to claim 8, the process further comprising:
encrypting the file data by an encryption key to generate encrypted data; and
using the encrypted data and the encryption key as the multiple tallies.
